(19) United States
(12) Patent Application Publication
(10) Pub. No.: US 2011/0233916 A1
(43) Pub. Date: Sep. 29, 2011

(54) BOOKS AS ART

(76) Inventor: Michael HOWARD, Temple Hills, MD (US)

(21) Appl. No.: 13/074,826

(22) Filed: Mar. 29, 2011

Related U.S. Application Data
(60) Provisional application No. 61/318,488, filed on Mar. 29, 2010.

(51) Int. Cl. B42D 17/00

(52) U.S. Cl. 281/43

(57) ABSTRACT

The invention relates to a book that can be displayed on a vertical surface like art work, a fastening mechanism for keeping the front and back covers of a book closed while the book is displayed vertically, a kit for use with a book that enables the book to be displayed on a vertical surface with a fastening mechanism, a method for displaying a book on a vertical surface, and a process for manufacturing a book that provides the same functionality.

### CROSS REFERENCE TO PRIOR APPLICATIONS

This application claims priority and the benefit thereof from a U.S. Provisional Application No. 61/318,488, filed on Mar. 29, 2010 and entitled BOOKS AS ART, the entire contents of which are herein incorporated by reference in its entirety.

### FIELD OF THE INVENTION

The invention relates to a book that can be displayed on a vertical surface like art work, a fastening mechanism for keeping the front and back covers of a book closed while the book is displayed vertically, a kit for use with a book that enables the book to be displayed on a vertical surface with a fastening mechanism, a method for displaying a book on a vertical surface, and a process for manufacturing a book that provides the same functionality.

### BACKGROUND OF THE INVENTION

As seen in libraries and bookstores, books are typically stored on bookshelves with only the spine of a book visible to its audience. Books can take up much space and bookshelves are an efficient way to display books. Unfortunately the spine of a book usually contains only the book's title, which may tell the reader nothing about its subject matter and does little to attract a potential reader's attention.

Book covers are important in the publishing industry and typically designed by professional illustrators. The book cover design is one method used by publishers to advertise and market the book. Book covers can visually attract potential readers to read and potential purchasers to purchase the books.

The importance of a book's cover can also be seen in bookstores, where some books are displayed with its front cover visible along a rack, similar to how magazines are displayed “face up” on a magazine rack. In libraries, some books are displayed in whole by placing the book free standing on top of the bookshelf, on tables, and on other flat horizontal surfaces. Books are displayed this way to make them more visually appealing and may enable these books to be checked out or purchased more frequently than books visible only by its spine. This may be particularly true for children, especially young children when selecting children's books such as board books or picture books. In book selection, young children may not be reading the book summary located in the back or inside book cover, but rather may gravitate towards visually stimulating books that catch their attention. However, the number of books that can be displayed in this manner is limited by the flat horizontal space available.

There is a need for books such as children's books to be displayed showing the book's front cover on a vertical surface such as a wall, refrigerator, or desk in an efficient space saving manner while visually enticing and stimulating the audience to take the book and read it.

### SUMMARY OF THE INVENTION

The invention, as described below discloses hardcover and soft cover books, such as children's books, displayed as hanging pieces of art on a vertical surface and a method for displaying such books as works of art. The invention also describes closing or fastening mechanisms for keeping the front and back covers of a book closed while the book is displayed vertically. The invention also describes a kit for use with a book that enables the book to be displayed as art. The invention also describes a process for manufacturing a book that provides the same functionality as a book as art.

The invention involves a book including a front cover, back cover, top, bottom, and two sides. The book includes at least one attachment mechanism that attaches the back cover of the book (or the front cover) to a vertical surface such as a wall. The book attachment mechanism may be provided as part of an assembly kit for users to temporarily or permanently attach the attachment mechanism to the book cover. Alternatively, the attachment mechanism may be embedded in or permanently affixed to the book by the manufacturer during the book's manufacturing process. The attachment mechanism may by any known method, including without limitation, self-adhesive hook and loop fasteners (e.g., Velcro), magnets, rubber cement glue, string, or the like. Alternatively, the book may include at least one front or back cover including magnetic material where no attachment mechanism may be necessary to attach the book to a metal surface such as a refrigerator or white board.

The invention also involves a book closing or fastening mechanism to keep the book in a closed position while the book is being displayed as art in a vertical position. The fastening mechanism may be provided as part of an assembly kit for users to temporarily or permanently attach the fastening mechanism to the book. Alternatively, the fastening mechanism may be embedded in or permanently affixed to the book by the manufacturer during the book's manufacturing process. The fastening mechanism may originate from the back outside cover to fasten to the outside front cover of a book, or may be a fastening mechanism fastening the back inside cover to the front inside cover. The fastening mechanism may be by any known method, including without limitation, self-adhesive hook and loop fasteners (e.g., Velcro), magnets, leather, string, buttons, snaps, clamps, latches, links, hooks, or the like.

One advantage of this invention is that books as art may visually entice and stimulate users, such as a children, to take a book down from a vertical surface and read the book or request that the book be read to them. Books as art may inspire reading literacy, particularly in children, who may be more apt to gravitate towards a visually appealing book, rather than the book that is “out of sight, out of mind” when placed spine facing forward in a bookshelf. In addition, the placement of the book makes it easy to remove from a vertical surface, read, and put back on a vertical surface when done.

Another advantage of this invention is that the books themselves may be transformed into a work of art, to display as one would any piece of art such as a painting or sculpture. Books as art may be displayed along any vertical surface, including metal surfaces, and used to decorate a child's bedroom or playroom, a parent's desk, or even the refrigerator. Books as art also has an added benefit of being a space saver and effectively using free space such as walls, and can un-clutter a child's bookshelf, bedroom or play area.

Additional features, advantages, and embodiments of the invention may be set forth or apparent from consideration of the following detailed description and drawings. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 shows examples of books displayed on a wall and a refrigerator.

FIG. 2A shows an example of a front inside cover of a book using magnets as the attachment mechanism to display the book on a vertical surface and a magnet as the book's fastening mechanism.

FIG. 2B shows an example of a back inside cover of a book using magnets as the attachment mechanism to display the book on a vertical surface and a magnet as the book's fastening mechanism.

FIG. 3A shows an example of a back outside cover of a book using self-adhesive hook and loop fasteners (e.g., Velcro) as the attachment mechanism to display the book on a vertical surface.

FIG. 3B shows an example of self-adhesive hook and loop fasteners attached to a wall in strategic locations in order to display a book using self-adhesive hook and loop fasteners as the attachment mechanism.

FIG. 4A shows an example of a front outside cover of a book using string fastened to the back cover and a button fastened to the outside front cover as the book's fastening mechanism.

FIG. 4B shows an example of a back outside cover of a book using Velcro as the attachment mechanism to display the book on a vertical surface and string as the book's fastening mechanism.

FIG. 5 shows an example of outside front covers of books using magnets as the attachment mechanism to display the books on a magnetic vertical surface and Velcro as the books' fastening mechanism.

FIG. 6 shows an example of back outside covers of books using magnetic strips as the attachment mechanism to display books on a magnetic vertical surface and cloth fastening straps as the books' fastening mechanism.

The invention is further described in the detailed description that follows.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the attached description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The invention describes a new approach to books as art, an assembly kit used to convert books to books as art, a process for manufacturing the books as art, as well as a mechanism for displaying books as art.

The book may also include at least one closing or fastening mechanism so as to keep the book in a closed position while the book is displayed on the vertical surface. The fastening mechanism may be secured along the back cover or back inside cover, and at least the other end of the fastening mechanism may be secured along the front cover or front inside cover of the book to securely fastening the book. The fastening mechanism may include any known mechanism, such as buttoning; pressing; tying; latching, hooking, snapping, and sticking. The book may be displayed as art in an open or closed position.

The invention may be sold as a kit, with or without a book, and may contain assembly components such as a fastening mechanism to secure the front and back of the book together, and an attachment mechanism to attach the book to any vertical surface such as a wall, door, and the side of a dresser, bookshelf, or desk. This kit can be used to modify the book in accordance with the aspects of the invention.

The invention may include at least one attachment mechanism and at least one fastening mechanism may also be affixed directly in the book during the book's manufacturing process. In this aspect, the book is ready for display without use of a kit to display the book.

The invention also involves a methodology for readily and easily displaying the book along a vertical surface in an aesthetically pleasing manner. At least one attachment mechanism is attached to or integrated into the back outside or back inside cover of the book. The corresponding attachment mechanism is attached to the vertical surface, if applicable. Alternatively, the book may include at least one front or back cover including magnetic material. A book including a magnetic front and or back cover, or using a magnetic attachment mechanism will not require a corresponding attachment mechanism to be attached to a metal vertical surface. The book is displayed along the vertical surface by aligning the attachment mechanism on the back of the book with the corresponding attachment mechanism along the vertical surface and applying pressure. The fastening mechanism may be attached to at least the back outside or back inside cover of the book, and the other end to the front outside or front inside cover of the book. The books as art may be closed by taking the unattached end of the closing or fastening mechanism and attaching it to the front of the book by at least one of buttoning; pressing; tying; latching, hooking, snapping, and sticking. The books as art may be displayed in an open position by releasing the closing or fastening mechanism by at least one of unbuttoning; untying; unlatching; unhooking; unsnapping; and unsticking the closing or fastening mechanism from the front of the book.

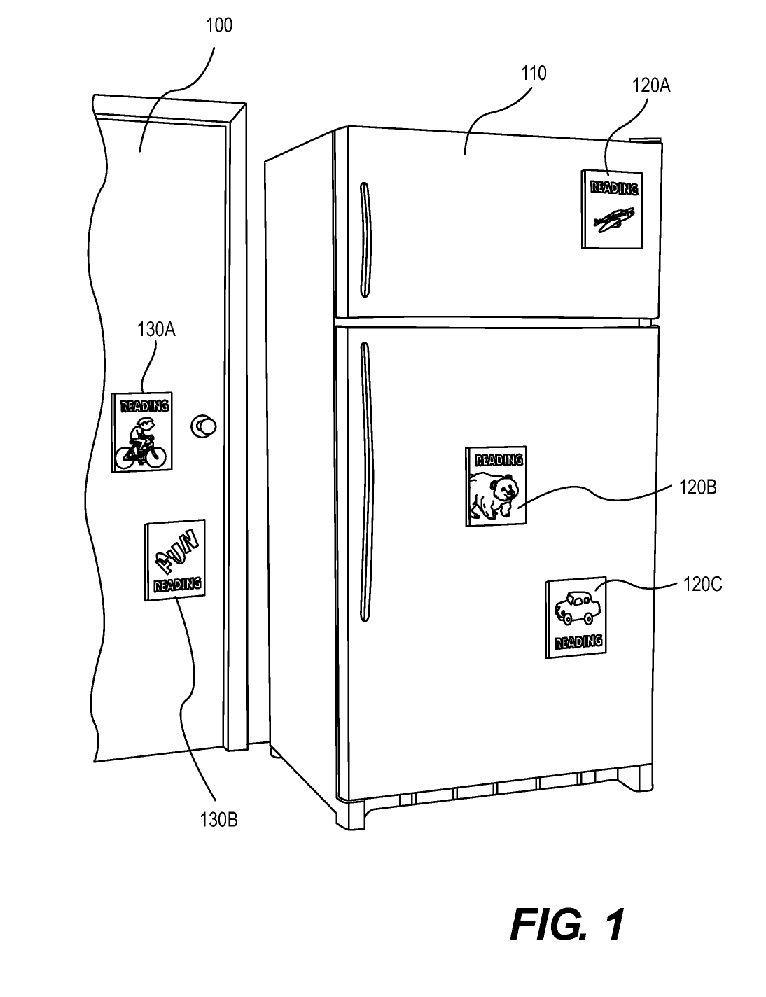

FIG. 1 shows examples of books displayed on a wall and a refrigerator.

Referring to FIG. 1, books 130A, 130B may be displayed like artwork on any vertical surface such as a wall, or a door 100 by using an attachment mechanism of the invention. Books 120A, 120B may also be displayed like artwork on a metal vertical surface such as a refrigerator 110, chalkboard, metal door, or the like.

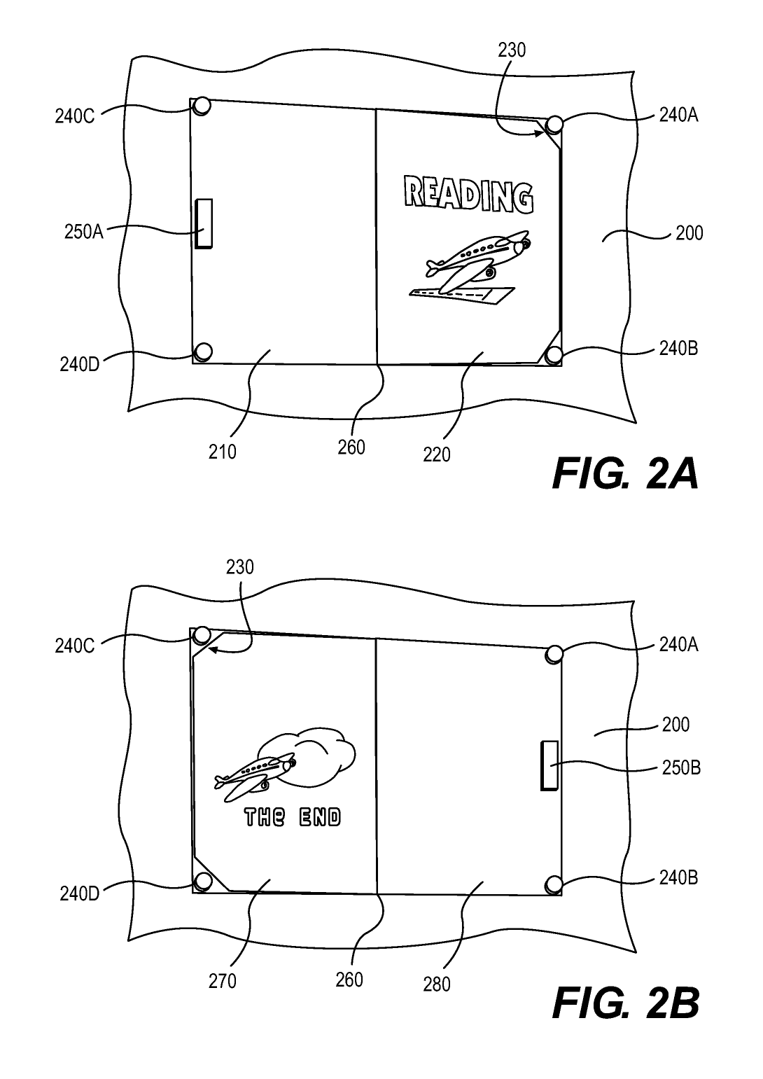

FIG. 2A shows an example of a front inside cover of a book using magnets as the attachment mechanism to display the book on a vertical surface and a magnet as the book's fastening mechanism. FIG. 2B shows an example of a back inside cover of a book using magnets as the attachment mechanism to display the book on a vertical surface and a magnet as the book's fastening mechanism.

Referring to FIGS. 2A and 2B, in this aspect, magnets may be used as the attachment mechanism to display the book on a metal vertical surface 200 and as the fastening mechanism to close the book, where the magnets are strategically placed. For example, the magnets may be placed on the book's upper right corner 240A of the back inside cover 280, the bottom right corner 240B of the back inside cover 280, the top left corner 240C of the front inside cover 210, and the bottom left corner 240D of the front inside cover 210. Magnetic strips may also be placed in the inside edge 250A of the front inside cover 210 as well as in the outside edge 250B of the back inside cover 280. The magnets used may be of any shape, size, color or number, so long as the shape, size or number are adequate for the book to display correctly on the vertical surface and to close correctly when in the closed position. In this aspect, all the pages of the book from the front inside page 220 through the back inside page 270 may have the corners cut from the pages 230 in order to place the magnets inside the book. However, arrangements without cut corners are also contemplated. The reader may close the book along the books spine 260 by aligning magnets 240A with 240C, 240B with 240D, and 250A with 250B. This book may have a front cover 210 or back cover 280 including a magnetic material and no attachment mechanism would be necessary to display the book on a metal surface 200. This book may also use other attachment mechanisms not shown in this FIG. 1 such as Velcro to display the book on a non-metal vertical surface.

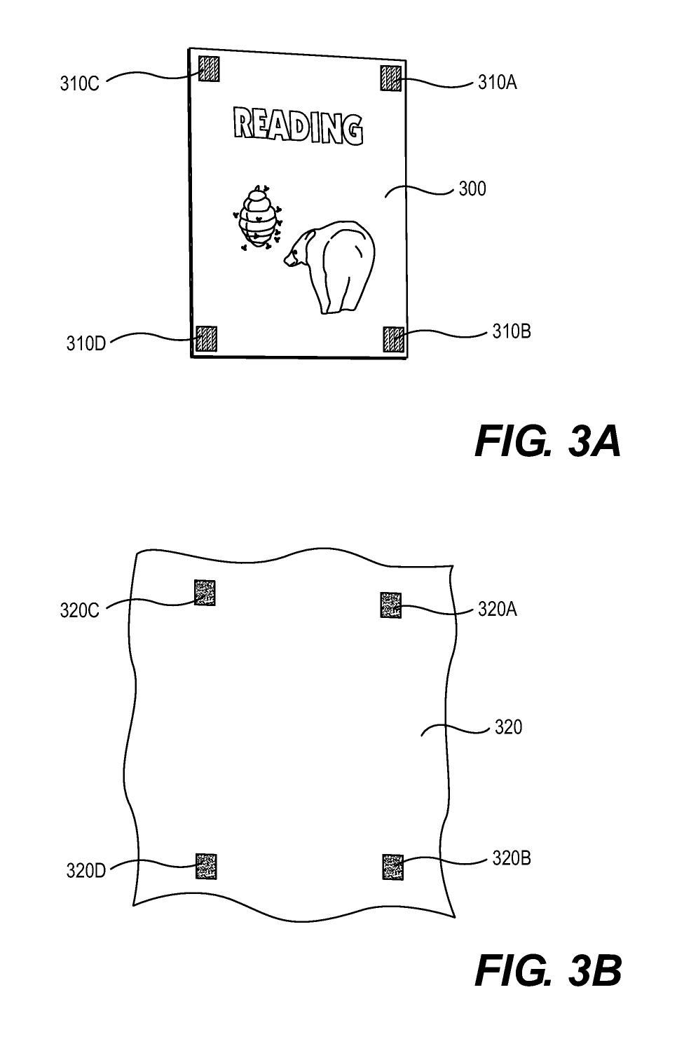

FIG. 3A shows an example of a back outside cover of a book using self-adhesive hook and loop fasteners (e.g., Velcro) as the attachment mechanism to display the book on a vertical surface. FIG. 3B shows an example of self-adhesive hook and loop fasteners attached to a wall in strategic locations in order to display a book using self-adhesive hook and loop fasteners as the attachment mechanism.

Referring to FIGS. 3A and 3B, the back outside cover of a book 300 is shown using Velcro as the attachment mechanism. In FIG. 3A, the Velcro, with a self-adhesive back, may be strategically placed on the book's upper right hand corner 310A and pressed firmly into place. Other Velcro pieces may be strategically placed anywhere on the book such as along the book's bottom right hand corner 310B, the upper left hand corner 310C, and the bottom left hand corner 310D and pressed firmly into place. The corresponding Velcro pieces may be placed on a vertical or semi-vertical surface 320 such that when the book is displayed on the vertical surface 320, Velcro piece 310C is aligned with 320A, 310D is aligned with 320B, 310A is aligned with 320C, and 310B is aligned with 320D. In addition to self-adhesive, the Velcro may also be attached to the book by other means such as sewn, stapled, and glued or the like to the book. The corresponding Velcro pieces may be attached to the vertical surface with self-adhesive, glue or other sticky materials. The Velcro used may be of any shape, size, color or number, so long as the shape, size or number are adequate for the book to display correctly on the vertical surface.

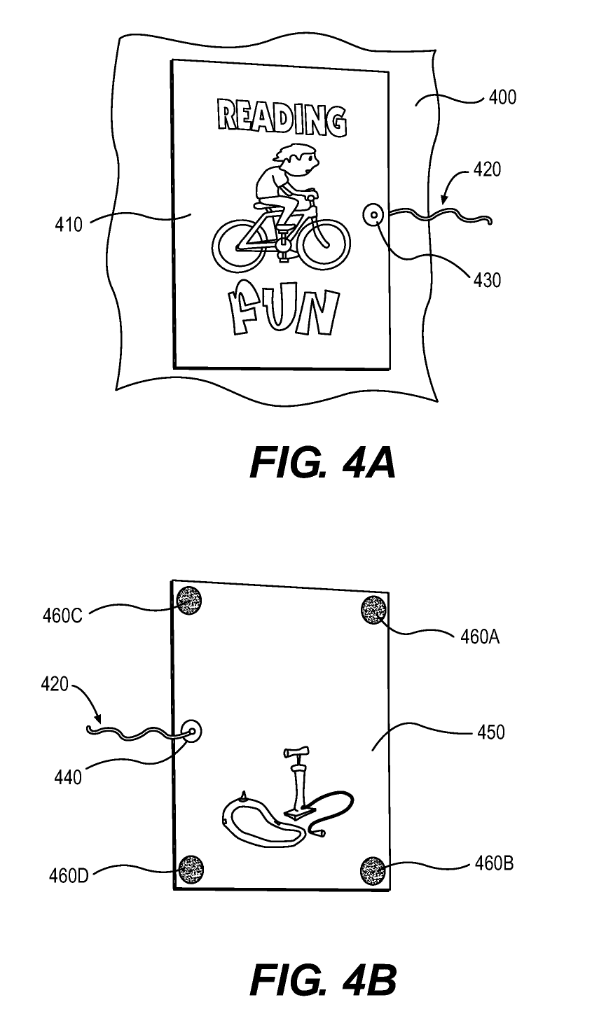

FIG. 4A shows an example of a front outside cover of a book using string fastened to the back cover and a button fastened to the outside front cover as the book's fastening mechanism. FIG. 4B shows an example of a back outside cover of a book using Velcro as the attachment mechanism to display the book on a vertical surface and string as the book's fastening mechanism.

Referring to FIGS. 4A and 4B, the back outside cover of a book 450 is shown using Velcro as the attachment mechanism to display the book on a vertical surface 400, with a string 420 and button 430 fastening mechanism. In FIG. 4B, the Velcro, with a self-adhesive back, is strategically placed on the book, such as the book's upper right hand corner 460A and pressed firmly into place. Other Velcro pieces may be strategically placed on the book such as along the book's bottom right hand corner 460B, the upper left hand corner 460C, and the bottom left hand corner 460D and pressed firmly into place. In addition to self-adhesive, the Velcro may also be attached to the book by other means such as sewn, stapled, or glued to the book. The Velcro used may be of any shape, size, color or number, so long as the shape, size or number are adequate for the book to display correctly on the vertical surface.

A piece of string 420 is attached to the back outside cover 450 of the book at 440 along the books outside edge. A button 430 is attached to the front outside cover 410 of the book along the book's outside edge to align with the string 420 attached at 440. The book may be closed by taking the unattached end of the string 420 and attaching it to the button 430 at the front of the book by winding the string 420 around the button 430 until the book is properly secured in the closed position. The string 420, button 430, and string attachment 440 may be of any shape, size, color, or number, so long as the shape, size or number are adequate for the book to display correctly on the vertical surface and close correctly when in the closed position.

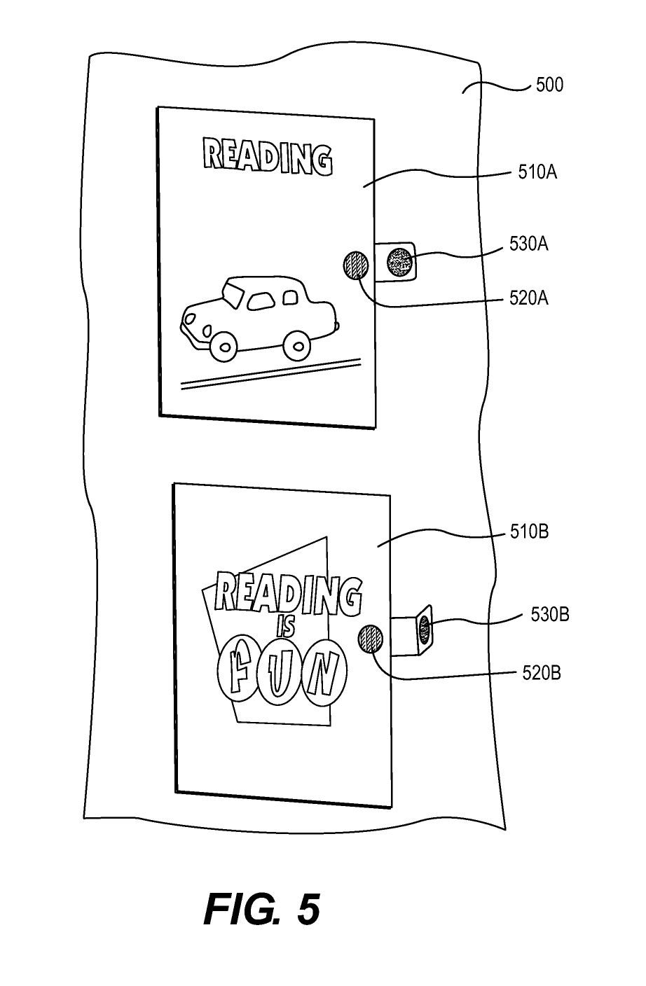

FIG. 5 shows an example of outside front covers of books using magnets as the attachment mechanism to display the books on a magnetic vertical surface and Velcro as the books' fastening mechanism.

Referring to FIG. 5, magnets may be used as the attachment mechanism to display the books 510A, 5108 on the refrigerator 500 or any other metal surface. Alternatively, a book with at least one front or back cover including a magnetic material may be used in lieu of an attachment mechanism to display the books 501A, 5108 on the refrigerator 500 or any other metal surface. Straps with Velcro at the end of the strap 530A, 530B may be used as the books 510A, 5108 fastening mechanism. The straps with Velcro at the end 530A, 530B are attached to the back outside cover or back inside cover of the book using attaching methods as previously described. The corresponding Velcro pieces 520A, 520B may be attached to the front of the book using glue, self-adhesive, and other methods as previously described. The book 510A may be closed by taking the Velcro on the end of the strap 530A and pressing it into the corresponding Velcro piece 520A. The book 510A may be closed by taking the Velcro on the end of the strap 530A and pressing it into the corresponding Velcro piece 520A. The Velcro 520A, 520B and strap 530A, 530B used may be of any shape, size, color, or number, so long as the shape, size or number are adequate for the book to close correctly when in the closed position along the vertical surface.

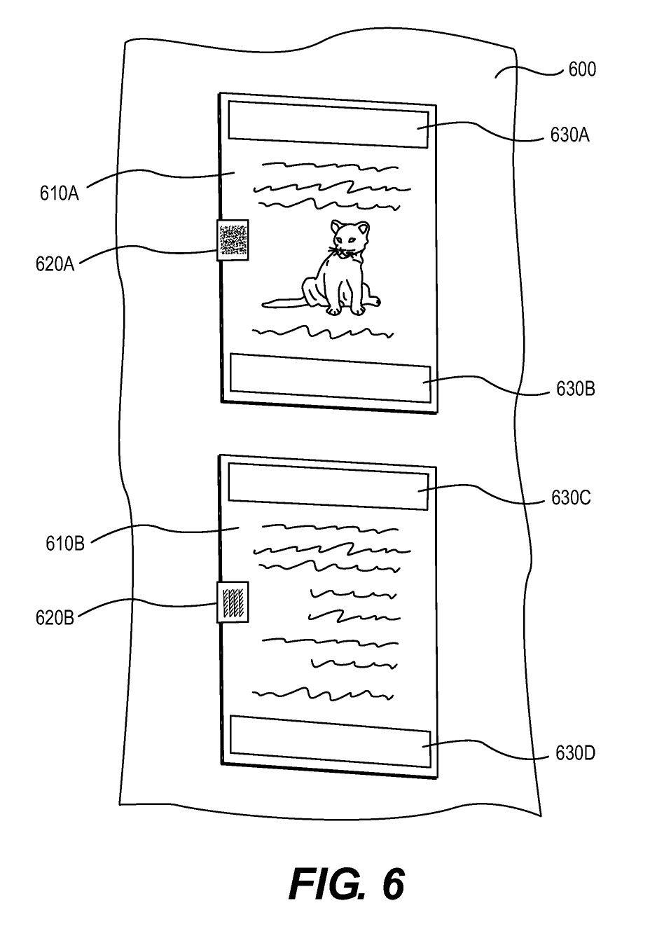

FIG. 6 shows an example of back outside covers of books using magnetic strips as the attachment mechanism to display books on a magnetic vertical surface and cloth fastening straps as the books' fastening mechanism.

Referring to FIG. 6, magnets may be used as the attachment mechanism to display the books on the refrigerator 600 or any other metal surface. Cloth fastening straps 620A, 620B may be used as the books' fastening mechanisms. A magnetic strip 630A may be attached to the edge of the top back outside cover 610A, and a magnetic strip 630B may be attached to the edge of the bottom back outside cover 610A of one book. A magnetic strip 630C may be attached to the edge of the top back outside cover 610B, and a magnetic strip 630D may be attached to the edge of the bottom back outside cover 610B of the other book. Alternatively, the magnetic strips may be embedded in the book cover. The cloth fastening straps 620A, 620B may be affixed along the edge of the back outside cover 610A, and 610B respectively, by glue or any other means as previously described. The magnet strips 630A-D used may be of any shape, size, color or number, so long as the shape, size or number are adequate for the book to display correctly on the vertical surface. The fastening straps 620A, 620B may be of any shape, size, color or number, so long as the shape, size or number are adequate for the book to close correctly when in the closed position along the vertical surface.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

What is claimed:

1. A book configured to be displayed on a vertical surface having at least front and back cover surfaces, comprising:
at least one attachment mechanism to attach at least the back cover of the book to a vertical surface;
at least one fastening mechanism to keep the book in a closed position while the book is displayed on the vertical surface; and
at least one portion of the fastening mechanism is arranged along the back outside cover or back inside cover and at least another portion of the fastening mechanism is secured along the front outside cover or front inside cover of the book to securely fasten the book.

2. The book of claim 1, wherein the book cover comprises one of a hard cover and a soft cover.

3. The book of claim 1, wherein the attachment mechanism comprises at least one of:
self-adhesive hook and loop fasteners;
magnets;
adhesive; and
string.

4. The book of claim 3, wherein a portion of the attachment mechanism is configured to be removable from the back cover of the book and configured to be re-useable.

5. The book of claim 3, wherein a portion of the attachment mechanism is configured to be removable from the vertical surface and configured to be re-usable.

6. The book of claim 3, wherein the attachment mechanism is at least one of permanently affixed and embedded in the back cover of the book.

7. The book of claim 3, wherein the attachment mechanism is arranged with the back cover at least at one of:
corner edges;
along a top;
along a bottom;
along a side; and
in a center.

8. The book of claim 1, wherein the fastening mechanism comprises at least one of:
self-adhesive hook and loop fasteners;
magnets;
strings;
buttons;
snaps;
straps;
clamps;
latches;
links; and
hooks.

9. The book of claim 8, wherein the material of the fastening mechanism comprises at least one of:
paper;
leather;
plastic;
adhesive;
metal;
cotton;
polyester;
nylon; and
rayon.

10. The book of claim 8, wherein the fastening mechanism is configured to be removable from the back cover and or front cover of the book and configured to be re-useable.

11. The book of claim 8, wherein the fastening mechanism is permanently affixed or embedded in the back cover and or front cover of the book.

12. A kit for use with a book configured to be displayed on a vertical surface having at least front and back cover surfaces, comprising:
at least one attachment mechanism to attach at least the back cover of the book to a vertical surface; and
at least one fastening mechanism to keep the book in a closed position while the book is displayed on the vertical surface; and
at least one portion of the fastening mechanism is arranged along the back outside cover or back inside cover and at least another portion of the fastening mechanism is secured along the front outside cover or front inside cover of the book to securely fasten the book.

13. A method for using a kit to display a book on a vertical surface, comprising:
attaching an attachment mechanism to at least one of a back outside cover and back inside cover of the book;
attaching one end of a fastening mechanism to at least one of the back outside cover and back inside cover of the book;
attaching another end of the fastening mechanism to at least one of the front outside cover and front inside cover of the book; and
hanging the book on the vertical surface by aligning the attachment mechanism on the back of the book with the corresponding attachment mechanism along the vertical surface.

14. The method according to claim 13 further comprising: attaching a corresponding attachment mechanism to a vertical surface.

15. The method according to claim 13 further comprising: closing the book by taking the unattached end of the fastening mechanism and attaching it to the front of the book by at least one of: buttoning; pressing; tying; winding, latching; hooking; snapping; and sticking.

16. The method according to claim 13 further comprising: opening the book from an open position by releasing the fastening mechanism by at least one of unbuttoning; pulling; untying;
unwinding, unlatching; unhooking; unsnapping; and unsticking the fastening mechanism from the front of the book.

17. A process for manufacturing a book comprising:
attaching at least one attachment mechanism to at least one of a back outside cover and back inside cover of the book;
attaching one end of at least one fastening mechanism to at least one of a the back outside cover and back inside cover of the book; and
attaching another end of at least one fastening mechanism to at least one of the front outside cover and front inside cover of the book.

18. The process according to claim 17 further comprising: supplying a corresponding attachment mechanism to be used on a vertical surface.

19. A method of using a book manufactured with at least one attachment mechanism and one fastening mechanism to display the book on a vertical surface such as a wall, comprising:
hanging the book on the vertical surface by aligning the attachment mechanism built into the back of the book with the corresponding attachment mechanism along the vertical surface;
closing the book by taking an unattached end of the fastening mechanism and attaching it to the front of the book; and
opening the book from an open position by releasing the fastening mechanism.

20. The method according to claim 19 further comprising: attaching the corresponding attachment mechanism to a vertical surface.
